(19) United States
(12) Patent Application Publication
(10) Pub. No.: US 2015/0176182 A1
(43) Pub. Date: Jun. 25, 2015

(54) METHOD AND APPARATUS FOR CONTROLLING A WASHING MACHINE

(71) Applicant: Dongbu Daewoo Electronics Corporation, Seoul (KR)

(72) Inventor: Wonick CHOI, Seoul (KR)

(73) Assignee: Dongbu Daewoo Electronics Corporation, Seoul (KR)

(21) Appl. No.: 14/178,785

(22) Filed: Feb. 12, 2014

(30) Foreign Application Priority Data
Dec. 23, 2013 (KR) 10-2013-0161055

(51) Int. Cl. D06F 37/30; D06F 35/00; H02P 23/00; D06F 33/02

(52) U.S. Cl. CPC D06F 37/304; D06F 33/02; D06F 35/005; H02P 23/0063

(57) ABSTRACT

A method and apparatus for controlling an operation of a washing machine including, a motor driving unit configured to drive a motor and cause a drum to rotate and a control unit configured to control the motor driving unit to (i) rotate the drum after completing a primary spin cycle, and (ii) stopping rotation of the drum and/or the driving the motor immediately when the rotational speed of the motor reaches a preset value.

### CROSS-REFERENCE RELATED APPLICATIONS

This application is based on and claims priority of Korean Patent Application No. 10-2013-0161055, filed on Dec. 23 2013, the disclosure of which is incorporated herein in its entirety by reference.

### FIELD OF THE INVENTION

The present invention relates to a method and apparatus for controlling one or more operations of a washing machine, and more particularly, to a method and apparatus for controlling operation(s) of a washing machine to achieve improved washing operation(s) and minimal vibrations of the washing machine.

### BACKGROUND OF THE INVENTION

A washing machine includes a water tub inside a rectangular exterior body, the water tub contains water therein for washing operation. The water tub attached to the body of the washing machine by one or more hanging rods.

To mitigate the friction between the hanging rod and the body of the washing machine caused by vibrations of the drum and/or tub during the washing operations, grease is applied to the upper and lower connectors of the hanging rod. However, the grease gradually diminishes over time, which may causes excessive vibrations.

Furthermore, in a fully automatic washing machine, after completing a washing cycle, the washing machine may enter a disentangling cycle for a certain period of time, followed by a rinsing cycle and a main spin cycle for water removal (e.g., dehydration). If tangled laundry is not properly disentangled or untangled by the disentangling operation, vibrations during the main spin cycle may occur, resulting in a longer operation time, louder noise, and additional wear on the washing machine.

### SUMMARY OF THE INVENTION

The present invention provides a method and apparatus for controlling one or more operation of a washing machine, wherein, after a washing cycle, a drum of the washing machine rotates at a constant speed and then immediately stops between a primary spin cycle and a rinsing cycle, moving the laundry on the inner wall of the drum (e.g., due to centrifugal force) toward the center of the drum by rotational inertia, thereby reducing or preventing excessive vibrations during a subsequent secondary spin cycle.

Furthermore, the present invention provides a method and apparatus for controlling an operation of a washing machine capable of evenly spreading grease in or on a hanging rod (e.g., in a groove thereof) by immediately stopping a rotating drum.

In accordance with embodiments of the present invention, a method for controlling an operation of a washing machine may comprise (i) rotating a drum by driving a motor of the washing machine after completing a primary spin cycle; and (ii) stopping rotation of the drum and/or the driving the motor immediately when the rotational speed of the motor reaches a preset value.

In embodiments of the present invention, the method further comprises repeating the steps of rotating the drum by driving the motor after completing the primary spin cycle, and stopping rotation of the drum and/or the driving the motor immediately when the rotational speed of the motor reaches the preset value, optionally for a predetermined number of times (e.g., 2, 3 or more).

In embodiments of the present invention, the preset value is within a range of 150 to 250 revolutions per minute (RPM) during the step of rotating the drum after completing a primary spin cycle. During the step of stopping rotation of the drum and/or the driving the motor immediately when the rotational speed of the motor reaches the preset value may comprise bringing the rotational speed of the drum and/or motor to 0 RPM when the rotational speed of the motor reaches the preset value.

In accordance with other embodiments of the present invention an apparatus for controlling an operation of a washing machine may comprise a motor driving unit configured to drive a motor and cause a drum to rotate; and a control unit configured to control the motor driving unit to (i) rotate the drum after completing a primary spin cycle and (ii) stopping rotation of the drum and/or the driving the motor immediately when the rotational speed of the motor reaches a preset value. The apparatus may further comprise the motor.

In embodiments of the present invention, the control unit is further configured to repeat (i) rotating the drum and (ii) stopping rotation of the drum and/or the driving the motor immediately when the rotational speed of the motor reaches the present value a predetermined number of times.

In embodiments of the present invention, the preset value is within a range of 150 to 250 RPM during rotation of the drum. The rotational speed of the motor may immediately stop (e.g., change to 0 RPM) when the rotational speed of the motor reaches the preset value. With the aforementioned configuration, it is possible to move the laundry on or at the inner wall of the drum toward the center of the drum by rotational inertia, thereby preventing excessive vibrations during a subsequent secondary spin cycle. Furthermore, it is possible to evenly spread grease in or on a hanging rod using the inertia when the rotating drum comes to a sudden stop. Consequently, the washing performance of the washing machine can be improved and excessive vibration of the washing machine can be prevented.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of an exemplary apparatus for controlling an operation of a washing machine in accordance with exemplary embodiments of the present invention;

FIG. 2 shows a cross-sectional view of part of a fully automatic washing machine implementing exemplary embodiments of the present invention; and

FIG. 3 presents a flow chart describing an exemplary method for controlling an operation of a washing machine in accordance with exemplary embodiments of the present invention.

### DETAILED DESCRIPTION OF THE EMBODIMENTS

The advantages and features of exemplary embodiments of the present invention and methods of accomplishing same will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Furthermore, the terms described below are defined in consideration of their functions in the embodiments of the invention and may vary depending on a user's or operator's intention or practice.

Hereinafter, the embodiments of the present invention will be described in detail with reference to the accompanying drawings.

### Exemplary Apparatus for Controlling an Operation of a Washing Machine

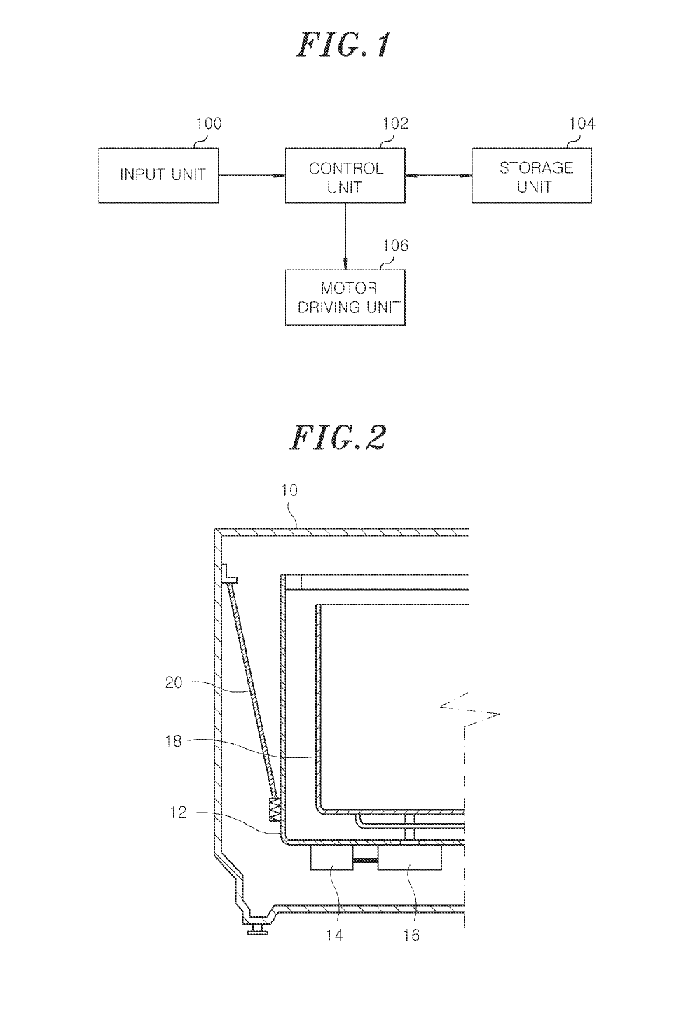

FIG. 1 shows a block diagram of an exemplary apparatus for controlling an operation of a washing machine in accordance with embodiments of the present invention. The exemplary apparatus includes an input unit 100, a control unit 102, a storage unit 104, and a motor driving unit 106.

As illustrated in FIG. 1, the input unit 100 generates and responds to a variety of input command signals for operating the washing machine through the control unit 102, which may include, for example, a keypad, a touch pad, and the like.

The control unit 102 controls operations of the washing machine in response to the respective input command signals from the input unit 100. For example, the control unit 102 controls an overall washing operation including washing, spinning, rinsing, and other processes by providing a driving control signal that corresponds to an input command signal from the input unit 100 to the motor driving unit 106.

The control unit 102 controls the motor driving unit 106 to drive the motor and rotate a drum after completing a primary spin cycle, then to immediately stop rotation of the drum when the spinning speed of the wash tub reaches a preset rate (e.g., RPM. The RPM of the drum may be obtained from the motor driving unit 106.

The storage unit 104 stores information necessary for the operation of the washing machine. Any information may be chosen by the control unit 102 as needed.

The storage unit 104 stores information, including, a preset RPM (e.g., at which rotation of the drum and/or driving of the motor is stopped), the number of repetitions for each cycle, and the like, which can be used to implement embodiments of the present invention.

The motor driving unit 106 is driven under the control of the control unit 102 for each of the different cycles of the washing machine (for example, a washing cycle, spin cycle, rinse cycle, drying cycles, and others).

Embodiments of the present invention may be characterized by rotating the drum until the spinning speed of the drum reaches the preset RPM after completing a primary spin cycle (or a pre-spin cycle), and then stopping rotation of the drum immediately. This process helps disentangle laundry on or at the inner wall of the drum by moving the laundry toward the center of the drum (e.g., by rotational inertia).

The laundry is pushed to the inner wall of the drum because of the centrifugal force created by spinning the drum during the primary spin cycle. This may cause the laundry to become tangled, either in the primary spin cycle or in a subsequent cycle (e.g., a rinsing cycle). Therefore, embodiments of the present invention are designed to rotate the drum, and then, to immediately stop the rotation of the drum, so that the laundry that has been pushed to the inner wall of the drum by centrifugal force moves toward the center of the drum. Accordingly, the laundry will be one or more evenly distributed in the drum, thereby preventing excessive vibration of the body of the washing machine during a subsequent secondary spin cycle (or other subsequent cycles, such as rinsing, drying, etc.).

Additionally, by rotating the drum and immediately stopping the drum, the grease applied to the upper and lower connectors of the hanging rod of the washing machine may be more evenly spread or distributed due to inertia caused by the sudden stoppage of the drum. In addition, even distribution of grease will alleviate effects of friction.

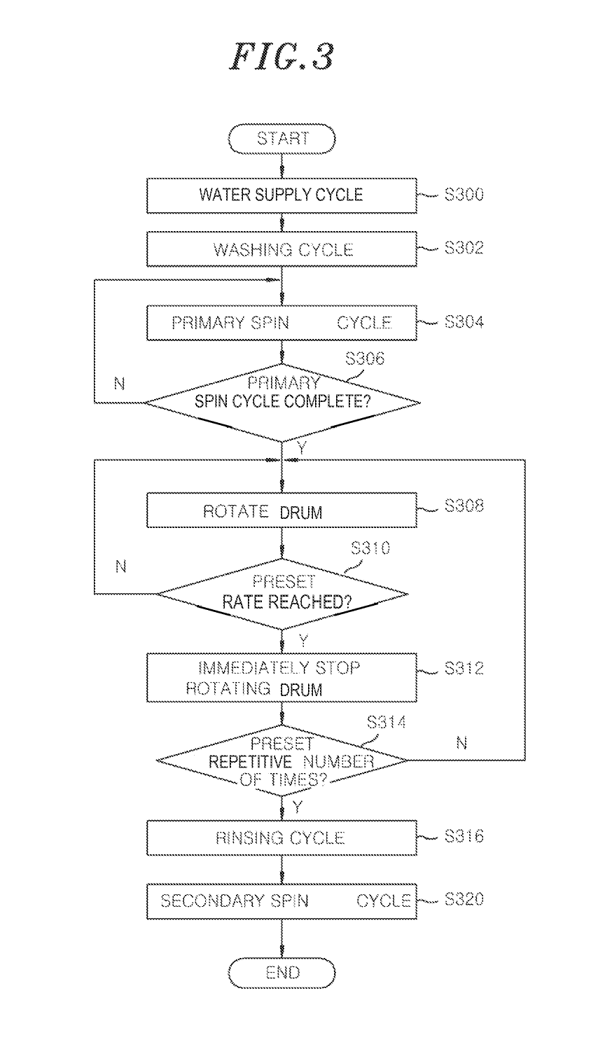

The operation of the washing machine will be understood more readily with reference to FIG. 2. FIG. 2 represents a partial cross-sectional view of the washing machine that can be used to implement embodiments of the present invention.

The washing machine, as illustrated in FIG. 2, comprises a body 10, a tub 12, a motor 14, a power conversion mechanism 16, a drum 18, and a hanging rod 20. The drum 18 is included inside the tub 12 and is rotated by driving the motor 14 in each cycle of the washing operation carried out by the washing machine.

The power conversion mechanism 16 selectively rotates the drum 18 or other agitation mechanism (e.g., an agitator or pulsator) (not shown) in the drum 18 in response to driving the motor 14. For example, a wash cycle or a rinse cycle is carried out by rotating the drum 18 or the agitation mechanism, and a spin cycle is carried out by rotating the drum 18. After completing the spin cycle, the laundry will usually be pushed to the inner surface of the side wall of the drum 18.

The hanging rod(s) 20 connect the body 10 and the tub 12, and mitigate vibrations of the body caused by the rotation of the drum 18. Grease is applied to the upper and lower connectors of the hanging rod(s) 20 to prevent abrasion and/or damage to the upper and lower connectors of the hanging rod(s) 20 due to friction caused by the rotation of the drum 18.

In accordance with embodiments of the present invention, the motor 14 is driven to rotate the drum 18 after completing the washing cycle and the primary spin cycle of the washing machine. When the rotational speed of the motor 14 reaches a preset RPM, the motor 14 immediately stops in order to terminate the rotation of the drum 18. This operation of the washing machine creates rotational inertia, which may help move the laundry from the inner wall of the drum 18 toward the center of the drum 18. In addition, grease applied to the upper and lower connectors may be more uniformly spread.

### Exemplary Software for Controlling an Operation of a Washing Machine

The present disclosure also includes algorithms, computer program(s), computer-readable media and/or software, implementable and/or executable in a general purpose computer or workstation equipped with a conventional digital signal processor, and configured to perform one or more of the methods and/or one or more operations of the hardware disclosed herein. Thus, a further aspect of the invention relates to algorithms and/or software that implement a method for controlling operation(s) of a washing machine and, in particular, detangling or redistributing laundry in a washing machine and/or distributing grease in or on a hanging rod suspension of a washing machine in accordance with the present disclosure. For example, the computer program or computer-readable medium generally contains a set of instructions which, when executed by an appropriate processing device (e.g., a signal processing device, such as a microcontroller, microprocessor or DSP device), is configured to perform the above-described method(s), operation(s), and/or algorithm(s).

The computer-readable medium may comprise any medium that can be read by a signal processing device configured to read the medium and execute code stored thereon or therein, such as a floppy disk, CD-ROM, magnetic tape or hard disk drive. Such code may comprise object code, source code and/or binary code. The code is generally digital, and is generally configured for processing by a conventional digital data processor (e.g., a microprocessor, microcontroller, or logic circuit such as a programmable gate array, programmable logic circuit/device or application-specific integrated circuit [ASIC]).

### Exemplary Methods for Controlling an Operation of a Washing Machine

Hereinafter, a method for controlling an operation of the washing machine will be described with reference to the flow chart depicted in FIG. 3 in more detail.

As shown in FIG. 3, when a driving command (e.g., to wash, rinse, spin-dry or dry the laundry) to the washing machine is issued from the input unit 100, the control unit 102 controls the motor driving unit 106 to carry out a water supply operation and a washing operation in blocks S300 and S302, respectively. Next, the control unit 102 controls the motor driving unit 106 to carry out a primary spin cycle (or a pre-spin cycle) in block S304. A series of the water supply, washing and primary spin cycles is a part of an entire automatic washing process that will be conducted sequentially in accordance with pre-stored operation information (e.g., in a memory associated with and/or accessible by the control unit 102).

Thereafter, the control unit 102 determines whether the primary spin cycle has been completed in block S306. When it is determined that the primary spin cycle has been completed, the control unit 102 controls the motor driving unit 106 to rotate the drum 18 in block S308. Alternatively, the control unit 102 automatically determines that the primary spin cycle is complete (e.g., by passage of a predetermined time, which may be set or determined by a timer), then automatically moves to the next step.

During the rotation of the drum 18 in block S308, the control unit 102 monitors the rotational speed of the motor 14 (e.g., using the motor driving unit 106), and determines whether the rotational speed of the motor 14 reaches the preset rate (e.g., RPM) in block S310. The preset RPM may be a value that does not cause excessive vibrations of the body 10, for example, a value in the range of from 150 to 250 RPM. However, the value and/or range of the RPM may be set differently in accordance with the characteristics of the washing machine and the like. Alternatively, the control unit 102 monitors the rotational rate or speed of the drum 18 (e.g., using a detector [not shown]), and determines whether the rotational speed of the drum 18 reaches the preset rate. The rate of the drum 18 may be a value in the range of from 150 to 250 RPM, for example. Furthermore, the control unit 102 and motor driving unit 106 may automatically stop at a preset rate or speed, without necessarily determining or monitoring the rotational rate or speed of the motor or drum.

When the rotational speed of the motor 14 reaches the preset RPM, the control unit 102 controls the motor driving unit 106 to immediately stop rotating the drum 18 in block S312. For example, the motor driving unit 106 may change the rotational speed of the motor 14 to zero RPM. By causing the drum 18 to rotate and then immediately stop, the laundry on or at the inner wall of the drum 18 will move toward the center of the drum 18, and the grease applied to the upper and lower connectors of the hanging rod 20 may spread more evenly due to inertia.

The aforementioned processes of blocks S308 to S312 may be repeated a predetermined number of times, which will be described in block S314. For example, the aforementioned processes of blocks S308 to S312 may be carried out two to four times to maximize even distribution of the laundry in the drum 18 and distribution of the grease. However, it will be appreciated by those skilled in the art that the number of repetitions is merely exemplary and may be adjusted depending on the characteristics of the washing machine.

Subsequently, if the processes of blocks S308 to S312 have been performed by the preset number of times in block S314, the control unit 102 proceeds with subsequent cycles (for example, a rinsing or rinse cycle and a secondary spin cycle) in blocks S316 and S318.

As described above, by causing the drum 18 to rotate and then immediately stop, the laundry on or at the inner wall of the drum 18 moves toward the center of the drum due to inertia, thereby preventing excessive vibrations during subsequent spin and/or rinse cycle. Furthermore, grease applied to the upper and lower connectors of the hanging rod 20 is more evenly distributed because of inertia, thereby alleviating or reducing the effects of friction. Accordingly, it is possible to achieve an improved washing operation of the washing machine and prevent excessive vibrations of the body of the washing machine.

While the invention has been shown and described with respect to the embodiments, the present invention is not limited thereto. It will be understood by those skilled in the art that various changes and modifications may be made without departing from the scope of the invention as defined in the following claims.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

5

What is claimed is:

1. A method for controlling an operation of a washing machine, comprising:
(i) rotating a drum by driving a motor of the washing machine after completing a primary spin cycle; and
(ii) stopping the drum and/or motor immediately when a rotational speed of the drum and/or motor reaches a preset value.

2. The method of claim 1, further comprising:
repeating the step of rotating the drum and stopping the drum and/or motor a predetermined number of times.

3. The method of claim 2, wherein the predetermined number of times is two to four times.

4. The method of claim 1, wherein the preset value is from 150 to 250 RPM.

5. The method of claim 1, wherein stopping the motor comprises changing the rotational speed of the motor to 0 RPM when the rotational speed of the motor reaches the preset value.

6. The method of claim 1, wherein stopping the drum comprises changing the rotational speed of the drum to 0 RPM when the rotational speed of the drum reaches the preset value.

7. The method of claim 1, further comprising receiving a driving command from the input unit, and carrying out a water supply operation and a washing operation prior to the primary spin cycle.

8. The method of claim 7, further comprising controlling the motor driving unit to carry out the primary spin cycle.

9. The method of claim 1, further comprising monitoring the rotational speed of the motor using the motor driving unit to determine whether the rotational speed of the motor has reached the preset RPM.

10. The method of claim 2, further comprising performing a rinsing cycle and a secondary spin cycle after repeating rotating the drum and stopping the drum and/or motor the preset number of times.

11. An apparatus for controlling an operation of a washing machine, comprising:
a motor driving unit configured to drive a motor and cause a drum to rotate; and
a control unit configured to control the motor driving unit to (i) rotate the drum after completing a primary spin cycle and (ii) stopping rotation of the drum and/or the driving the motor immediately when the rotational speed of the motor reaches a preset value.

12. The apparatus of claim 11, wherein the control unit is configured to control the motor driving unit to repeat (i) rotating the drum and (ii) stopping the drum and/or motor immediately a predetermined number of times.

13. The apparatus of claim 11, wherein the preset value is from 150 to 250 RPM.

14. The apparatus of claim 11, wherein the control unit changes the rotational speed of the motor to 0 RPM when the rotational speed of the motor reaches the preset value.

15. The apparatus of claim 11, wherein the control unit changes the rotational speed of the drum to 0 RPM when the rotational speed of the motor reaches the preset value.

16. The apparatus of claim 11, further comprising an input unit configured to receive and/or generate input command signals for operating the washing machine using the control unit.

17. The apparatus of claim 16, wherein the control unit comprises a keypad or a touch pad.

18. The apparatus of claim 11, further comprising one or more hanging rods connected to a body and a tub of the washing machine.

19. The apparatus of claim 11, wherein the hanging rod comprises upper and lower connectors, and grease on or in the upper and lower connectors.

20. A tangible computer readable medium having computer-readable instructions therein configured to control components of a refrigerator, said instructions being adapted to perform the method of claim 1.
